(19) United States
(12) Patent Application Publication
(10) Pub. No.: US 2007/0022851 A1
(43) Pub. Date: Feb. 1, 2007

(54) Method of cutting a plastic functional film which is applied to a substrate, such as a glass sheet

(75) Inventor: Ronan Garrec, Place de la Croix Blanche (FR)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: SAINT-GOBAIN GLASS FRANCE, Courbevoie (FR)

(21) Appl. No.: 10/564,524

(22) PCT Filed: Jul. 13, 2004
(86) PCT No.: PCT/FR04/01842

§ 371 Date: Jun. 9, 2006

(30) Foreign Application Priority Data
Jul. 17, 2003 (FR) 0350342

(51) Int. Cl. B26D 1/00; B26D 5/08

(52) U.S. Cl. 83/13; 83/617; 83/870

(57) ABSTRACT

A method of cutting a plastic functional film, in particular a protective film, which has been applied to a hard substrate, such as a glass sheet. The film is cut using an ultrasound cutting device having characteristics and parameters selected such that a cut is only made through the thickness of the functional film, leaving the underlying substrate intact.

The present invention relates to a method of cutting a plastic functional film applied to a substrate, this cut having to be made without damaging said substrate.

“Functional film” mainly means protective films, which may at the same time be decorative films, films comprising information such as installation and maintenance instructions and/or advertising information and mechanical reinforcement films. These films are peelable, being kept on the substrate by an electrostatic effect or because they are coated with adhesive at least on a part of their surface. It could however be envisaged that a part of the film is not peelable, the film having to be permanently kept on the substrate in this part.

The present invention relates in particular to the protection by film-wrapping of surfaces of substrates of plate types, in particular glass plates, for example intended for glazing units, so as not to damage them by impact, scratches, etc. when they are transported from the production site to a site of use or installation, and during said installation when the plate must be partly uncovered, the film protection on the remaining part having to be able to be retained for as long as possible.

Thus, glazing units handled, delivered to worksites, installed in window frames, remain subject to soiling and damage on the worksites, including soiling by render, coatings, mastics, paints, finger marks, etc. which may be applied after the glazing units have been put in place.

The glazing units may be conventional glazing units, with untreated surface, but increasingly frequently encountered are glazing units whose surface has been coated by at least one thin functional layer, of at least a metal oxide for example, such as a TiO₂-based layer, making the glazing unit self-cleaning (Bioclean glazing units of the Applicant Company).

Such glazing units are then not only sensitive to the soiling specified hereinabove, but also sensitive to pollution by certain mastics, particularly those incorporating certain silicones, and to the vapors of these mastics, such pollutants temporarily or even definitively destroying the self-cleaning function of these layers and requiring them to be cleaned to restore their effectiveness.

To protect the glazing units, both conventional and the glazing units called layered glazing units, they have applied to them, as indicated hereinabove, a peelable protective film which has to be retained until the worksite is finished, that is to say even after the glazing units have been installed. However, to carry out the installation, it is necessary to be able to clear only the edges of the glazing unit so as to be able to install the glazing units in the window frames. The film is usually removed on the edges to allow the mastic or the sealed contact of a seal to adhere on the glass, but the film must be retained on the “see-through” portion of the pane, the user peeling it off only at the end of the works. It could be envisaged to retain the film on the border, but a cut must also be provided on the periphery of the film in order to be able, finally, to remove the film from the “see-through” portion.

Furthermore, it is important to be able to clear these edges also without damaging the substrate, particularly to ensure that the seal is maintained.

The Applicant Company has sought a solution to the problem of protecting a substrate of the plate type while making it possible to remove various parts of the peelable film at different times (in the case of a glass pane, removal of the border strips during installation, the part of the film covering the “see-through” portion not being removed until later), the substrate at all times retaining its integrity.

The proposed solution consists of making a cut of the film by ultrasound in conditions that do not damage the substrate and any layers that it supports.

European patent application EP 0 999 088 A2 reveals an ultrasound cutting method, but it is clear that certainly the film is cut, but also the glazing unit is scratched in order to cut it. Such a scratching is prohibited in the conditions presently proposed.

The object of the present invention therefore is a method of cutting a plastic functional film, in particular a protective film, in the state applied to a hard substrate, such as a glass plate, characterized in that said cut is made with the aid of an ultrasound cutting device with a sonotrade head, whose characteristics and parameters have been selected so that the cut is made only in the thickness of the functional film while leaving the underlying substrate intact.

The hard substrate and the plastic film are materials that have a different behavior with ultrasound which allows a cutting of the soft material without risking damaging the hard material, to the extent that the parameters that are necessary for cutting the glass are very clearly different.

Advantageously, an ultrasound cutting device is used having a head intended to penetrate the functional film, which has an end portion in the general shape of the point with an angle at the apex at least equal to 30°, for example with an angle at the apex of the order of 70°. Using a head of this type (“non sharp”) prevents too strong a focusing of energy on a sharp point.

A point whose end is rounded, semispherical or has the shape of a point with a larger angle than the foregoing, having an angle genreally greater than 110°, being particularly of the order of 130°, may be chosen.

According to a first variant, a head is chosen having the general shape of a blade whose end is rounded in the mid-plane of the blade and has said end portion pointed along the plane perpendicular to the mid-plane of the blade. Such a head is schematized in FIG. 3 of the appended drawing in which the left part is a view along the mid-plane of the blade and the right part along the plane perpendicular to the foregoing. This shape called “half-round” has shown itself to be valuable because it allows a better clearance of the cutting residues.

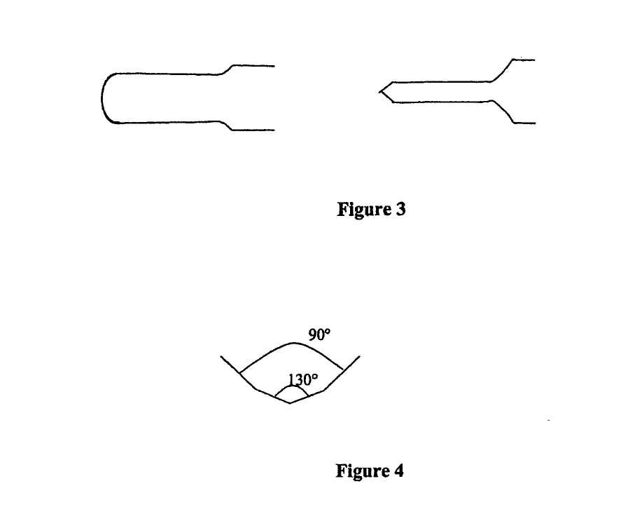

According to a second variant, a head is chosen having the shape of a cone whose angle at the apex is at least equal to 30°, being particularly of the order of 70°, the end of said cone being able to be rounded, semispherical or to have the shape of a cone of a larger angle than the foregoing, having an angle generally greater than 110°, being particularly of the order of 130°. Such a head is schematized in FIG. 4 of the appended drawing.

Use is made of a sonotrode head made of a material chosen in particular from steel, titanium and aluminum, said material having, where appropriate, received at least a surface treatment, such as a polish, the purpose of which in particular is the lubrication, the sliding along or the formation of a particular surface state, and/or at least one layer deposition. Materials such as diamond and tungsten carbide are generally not recommended, likewise any other material that would be recommended for cutting glass; however, particular applications may present themselves in which these materials could even so be envisaged.

An ultrasound system is used with a power of advantageously less than 1000 Watts, particularly less than 500 Watts, preferably 100-300 Watts, with an amplitude of vertical movement of the head of 2 to 40 μm.

An ultrasound system is used with a vibration frequency usually of 20 000 to 70 000 Hz.

The cut is made with a pressure of the head on the substrate coated with the protective film advantageously from a value corresponding to the tool placed on said coated substrate up to a value of 2 bar, particularly from 0.5 to 2 bar.

Advantageously, the cut is made with a movement of the substrate coated with the functional film relative to the head of 120 meters/min. at the most, particularly of 30 to 100 meters/min.

The substrate generally consists of a flat or curved or arched face plate of monolithic or laminated glass, or of a hard plastic such as polycarbonate, said plates having received, where appropriate, at least one treatment on at least one face, for example by the application of a functional layer, such as a dirt-repellent layer, a rain-repellent layer, an antireflection layer, an antiscratch layer, a sun-protection layer. The glass plates are particularly intended to form windows of buildings or motor vehicles or motor vehicle windshields.

The functional film is made of a plastic chosen from the polyolefins such as the low density, medium density and high density polyethylenes and their blends, and polypropylene, poly(vinylchloride)s and poly(ethylene terephthalate), where necessary coated with an acrylic adhesive layer. Acrylic films may also be cited. The functional film may also be formed of several layers each of which is formed of a plastic chosen from those that have just been indicated or is an acrylic layer.

The films used are advantageously nonpolluting, being weather and/or UV-resistant.

The functional film, being able, at least over a part of the substrate, to be applied in double thickness, advantageously has an overall thickness of between 20 and 200 μm, particularly between 80 and 160 μm.

If the substrate consists of a glazing unit, such as a self-cleaning glazing unit, coated for this purpose with a metal oxide layer such as TiO₂, a cut may be made which leaves the film on the main portion of the glass pane corresponding to the see-through portion, and which makes it possible to remove the film from the regions of the borders of the glazing unit, said borders being intended to be inserted into the rebates of the frames and to be hidden from view by cover strips.

If the substrate consists of a glass plate, it may also be necessary to make a cut that makes it possible to remove the film from any desired location to carry out therein a sandblasting process, or fit an accessory therein, or carry out a bonding of glazing bars on the glass to give a “small pane” effect or look, or to make a hole in the glass sheet in order to attach a through-mounting ball joint, the film being able to be cut along a perimeter greater than that of the hole, the edges of the hole cleared by the cutting of the film being able to take a seal, where necessary after an acid etching treatment of the glass thus cleared around the hole.

The subject of the present invention is a method for protecting at least one face of a substrate of the plate type during its transportation from the production site to a site of use or installation and during installation handling operations, at least one region of the surface of the substrate needing to be uncovered during the installation handling operations, the protection having to be maintained at least temporarily on the remaining region or regions, characterized in that a plastic protective film is deposited on the whole of each face to be protected of the substrate for its transportation, and that, to make it possible to remove the film in the region or regions that have to be uncovered, an ultrasound cut is made of said protective film along the contour of said region or said regions, particularly by the method as defined hereinabove using an ultrasound cutting device whose characteristics and operating parameters have been selected so that the cut is made only in the thickness of the protective film, leaving the underlying substrate intact.

The present invention relates also to substrates such as glass plates intended to form glazing units, windows of motor vehicles, windshields, coated with a functional film, said film comprising an ultrasound cut that has been made through its thickness without the underlying substrate being damaged, whether or not the cut parts have been removed.

Equally, the present invention relates to an apparatus for carrying out the ultrasound cutting method as defined hereinabove, said apparatus being automatic, semiautomatic or consisting of a portable tool, and comprising an ultrasound cutting device, as defined hereinabove.

In particular, as the apparatus for carrying out the ultrasound cutting method, a glass cutting table may be used onto which has been fitted an ultrasound film cutting device, said ultrasound cutting device being able for example to be mounted on a gantry or other element, being capable of moving in a single direction or in the two directions X,Y. Portable cutting tools may also be used, the weight of the tool determining the pressure of application of the sonotrode head on the film.

The edges of the films cut by the method of the invention are rounded because they have been melted, the trace of the melting having a width of at least 1 mm, particularly at least 1.5 mm.

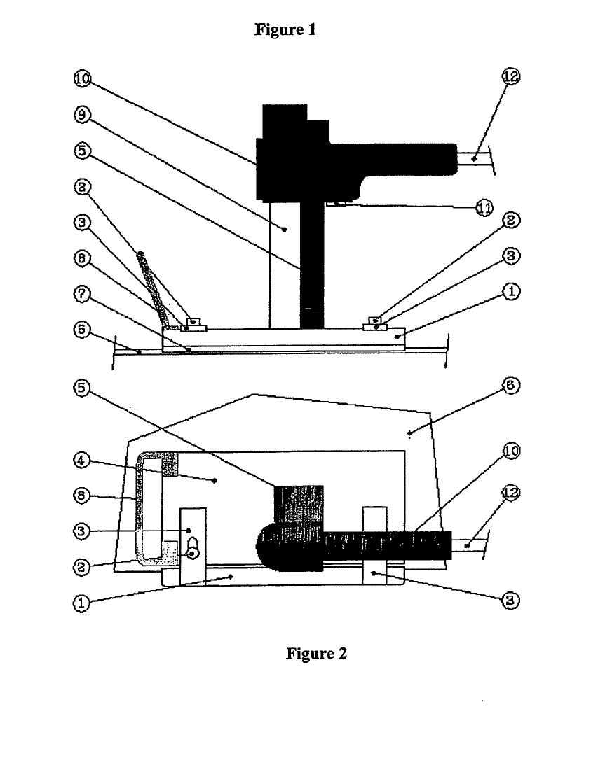

FIGS. 1 and 2 of the appended drawing represent schematically a cutting device according to the invention, respectively in side view and in top view, and FIGS. 3 and 4 each illustrate an example of a head intended to be fitted to the ultrasound system of the device of FIGS. 1 and 2.

The reference numbers appearing in FIGS. 1 and 2 have the following meanings:

1. Edge stop

2. Edge stop adjusting screw

3. Adjustment support

4. Support bed

5. Ultrasound system retention rod

6. Substrate, for example glass

7. “Soft” Teflon® skid

8. Guide handle

9. Sonotrode® head

10. Ultrasound system handle

11. Ultrasound system contact trigger

12. Ultrasound system power supply lead

With reference to FIGS. 1 and 2, it can be seen that a device for cutting a functional film applied to a substrate 6 has been represented. This device comprises a Sonotrode® head 9 held by a vertical rod 5 fixedly attached to a support bed 4 applied to the substrate 6 along a border of the latter. The head 9 traverses the bed 4 to reach the functional film to be cut on the margin of the glass. The bed 4 comprises a guide handle 8 at one of its ends transversal to the aforementioned border.

An edge stop 1 is applied along the border of the substrate 6, opposite the support bed 4. The distance of the latter relative to the border is adjusted with the aid of adjustment screws 2 traversing two adjustment supports 3 supported by the stop 1 in the vicinity of its ends and applied to the support bed 4.

The ultrasound system comprises a handle 10, the user moving the assembly along the border of the substrate gripping the handle 8 with one hand and the handle 10 with the other, having started the ultrasound system by pressing the trigger 11.

The functional film is then cut along a line parallel to the border of the substrate 6.

1-20. (canceled)

21. A method of cutting a plastic functional film, in a state applied to a hard substrate, comprising:
making a cut with aid of an ultrasound cutting device, whose characteristics and parameters have been selected so that the cut is made only in the thickness of the functional film while leaving the underlying substrate intact.

22. The method as claimed in claim 21, wherein in the making the cut use is made of an ultrasound cutting device having a head configured to penetrate the functional film, which has an end portion in a general shape of a point with an angle at the apex at least equal to 30°.

23. The method as claimed in claim 22, wherein the head has an end portion in a general shape of the point with the angle at the apex on the order of 70°.

24. The method as claimed in claim 22, wherein the end of the point is rounded, semispherical, or has a shape of a point with an angle greater than 110°.

25. The method as claimed in claim 22, wherein the head has a general shape of a blade whose end is rounded in mid-plane of the blade and has an end portion pointed along a plane perpendicular to the mid-plane of the blade.

26. The method as claimed in claim 22, wherein the head has a shape of a cone whose angle at the apex is at least equal to 30°, an end of the cone configured to be rounded, semispherical, or to have a shape of a cone having an angle generally greater than 110°.

27. The method as claimed in claim 22, wherein the head is made of a material chosen from steel, titanium, and aluminum, the material having received at least a surface treatment, a polish, formation of a particular surface state, and/or at least one layer deposition.

28. The method as claimed in claim 22, wherein the ultrasound cutting device has a power less than 1000 Watts, with an amplitude of vertical movement of the head of 2 to 40 μm.

29. The method as claimed in claim 21, wherein the ultrasound cutting device has a vibration frequency of 20,000 to 70,000 Hz.

30. The method as claimed in claim 22, wherein the cut is made with a pressure of the head on the substrate coated with the functional film from a value corresponding to a tool placed on the coated substrate up to a value of 2 bar.

31. The method as claimed in claim 22, wherein the cut is made with a movement of the substrate coated with the functional film relative to the head of 120 meters/min. at the most.

32. The method as claimed in claim 21, wherein the substrate includes a flat or arched plate of monolithic or laminated glass, or of a hard plastic, or of polycarbonate, the plate having received at least one treatment on at least one face, by application of a functional layer, a dirt-repellent layer, a rain-repellent layer, an antireflection layer, an antiscratch layer, or a sun-protection layer.

33. The method as claimed in claim 21, wherein the functional film is made of a plastic chosen from polyolefins, low density, medium density, and high density polyethylenes and their blends, polypropylene, poly(vinylchloride)s, and poly(ethylene terephthalate), coated with an acrylic adhesive layer, or an acrylic film, the film configured to be formed of plural layers each of which is formed of a plastic or an acrylic layer.

34. The method as claimed in claim 21, wherein the functional film is configured, at least on a portion of the substrate, to be applied in double thickness, and has an overall thickness of between 20 and 200 μm.

35. The method as claimed in claim 21, wherein the substrate includes a glazing unit, coated with a metal oxide layer or TiO₂, wherein the cut is made to leave the film on a main portion of a glass pane corresponding to a see-through portion of the glazing unit, and which makes it possible to remove the film from regions of borders of the glazing unit, the borders configured to be inserted into rebates of the frames and to be hidden from view by cover strips.

36. The method as claimed in claim 21, wherein the substrate includes a glass plate, and the cut is made to make it possible to remove the film from any desired location to carry out therein a sandblasting process, or fit an accessory therein, or carry out a bonding of glazing bars on the glass to give a small pane effect or look, or to make a hole in the glass sheet to attach a through-mounting ball joint, the film configured to be cut along a perimeter greater than that of the hole, edges of the hole cleared by the cutting of the film configured to take a seal, after an acid etching treatment of the glass thus cleared around the hole.

37. A method for protecting at least one face of a substrate of a plate during transportation from a production site to a site of use or installation and during installation handling operations, at least one region of the surface of the substrate needing to be uncovered during the installation handling operations, the protection having to be maintained at least temporarily on a remaining region or regions, the method comprising:
depositing a plastic protective film on the whole of each face to be protected of the substrate for its transportation; and
to make it possible to remove the film in the region or regions that have to be uncovered, making an ultrasound cut in the protective film along a contour of the region or regions.

38. A substrate configured to form a glazing unit, a motor vehicle window, or a windshield, coated with a functional film, the film comprising an ultrasound cut that has been made through its thickness without an underlying substrate being damaged, whether or not the cut parts have been removed.

39. An apparatus for carrying out the method of cutting by ultrasound as defined in claim 21, the apparatus being automatic, semiautomatic, or including a portable tool, and comprising the ultrasound cutting device.

40. The apparatus as claimed in claim 39, including a glass cutting table onto which the ultrasound cutting device has been fitted, the ultrasound cutting device configured to move in a single direction or in two directions.
